(19) United States
(12) Patent Application Publication
(10) Pub. No.: US 2011/0037928 A1
(43) Pub. Date: Feb. 17, 2011

(54) WIRE GRID POLARIZER FOR USE ON THE FRONT SIDE OFLCDS

(76) Inventor: Michael J. Little, Garden Valley, CA (US)

Correspondence Address: LUMEN PATENT FIRM, 350 Cambridge Avenue, Suite 100, PALO ALTO, CA, 94306, US

(21) Appl. No.: 12/736,647

(22) PCT Filed: May 1, 2008
(86) PCT No.: PCT/US08/62306

§ 371 Date: Oct. 26, 2010

(51) Int. Cl. G02F 1/1335

(52) U.S. Cl. 349/96

(57) ABSTRACT

A liquid crystal display may include a rear polarizer comprising a front and rear wire grid polarizer respectively having first and second pluralities of closely spaced parallel metallic lines. An optically absorptive material is disposed proximate a viewing side of the second plurality of closely spaced parallel metallic lines. A liquid crystal array may be disposed between the front polarizer and the rear polarizers. The front wire grid polarizer may include a plurality of closely spaced parallel metallic lines and an optically absorptive material disposed proximate one side of the metallic lines. The optically absorptive material may be configured such that said wire grid polarizer is characterized by reflectivity of less than 4%. Alternatively, the front polarizer may include a substrate having a plurality of ribs and an optically absorptive material disposed on said ribs proximate one side of said ribs.

### FIELD OF THE INVENTION

This invention generally relates to liquid crystal displays and more particularly to the front polarizers used in liquid crystal displays.

### BACKGROUND OF THE INVENTION

Liquid Crystal Displays (LCDs) have emerged to become the dominant technology for displaying graphic and video content. LCD manufacturers are continuing their aggressive pursuit of methods that improve both display performance and reduce costs. Polarizers, which are an essential component of LCDs, are the primary factor in determining the LCD's contrast and are one of the most expensive films in a LCD. However, the polarizer technology currently used for LCDs is very mature (developed in the late 1920's) has very little capacity for either further performance improvements or further cost reductions. An innovative new polarizer technology is needed that addresses both of these important goals.

A cross-sectional view of a typical LCD module is schematically shown in FIG. 1. The LCD module 10 is composed of two major subassemblies; (a) a Backlight Unit 20 that generates the illumination for the display and (b) a LCD Panel 40 that modulates the illumination on a pixel by pixel basis to produce the desired image.

The backlight assembly 20 is typically composed of a light source 201, a light guide 202, a reflector 204, and a diffuser 205. The backlight assembly may further include a cylindrical focusing element 203 that couples light from the light source into the light guide. The purpose of these components is to produce relatively uniform 2-dimensional illumination directed primarily towards the viewer 50. In many LCDs, there are additional optical films such as prism films 206a & 206b that redirect those rays of light that, in the absence of the prism films would exit at steep oblique angles and not be perceived by the viewer 50. The prism films redirect these oblique rays into a narrower cone of illumination that is aimed at the viewer 50 thereby increasing the amount of light available to the viewer. The illumination 210 provided by the backlight is unpolarized.

The liquid crystal panel assembly 40 is minimally composed of two polarizers 404 and 406 on either side of a liquid crystal array 402. Unpolarized light 210 emanating from the backlight is converted to polarized light by the rear polarizer 404. One plane of polarization 405 is transmitted by polarizer 404 while the orthogonal plane of polarization is absorbed by polarizer 404. The plane polarized light 405 that is transmitted by polarizer 404 is subsequently incident on the liquid crystal array whereupon, depending on the voltage applied to each liquid crystal pixel, the plane of polarization 405 is either rotated or not. The second polarizer 406 (the front polarizer) transmits the light emanating from the liquid crystal array in proportion to the degree of polarization rotation imparted by the liquid crystal pixels.

In substantially all of the LCDs manufactured to date, polarizers 404 and 406 are absorptive type polarizers, also known as dichroic polarizers. This type of polarizer produces linearly polarized light by substantially transmitting the desired plane of polarization 405 and strongly absorbing the orthogonal (unwanted) plane of polarization. The unwanted plane of polarization, once absorbed, is lost forever as a potential source of illumination for the LCD panel 402.

The two main performance parameters of polarizers are their Transmittance and Contrast Ratio. A high Transmittance value is desirable for it indicates that the polarizer film transmits a high fraction of the unpolarized incident light. A high Contrast Ratio is desirable for it indicates that only a small fraction of the transmitted light is of the unwanted plane of polarization.

The ratio of the intensity of the two planes of polarization (the transmitted intensity of the desired plane of polarization (T_{Parallel}) divided by the transmitted intensity of the unwanted plane of polarization (T_{perpendicular})) is known as the Contrast Ratio or extinction ratio.

An example of the typical performance values for absorptive polarizers currently used in LCDs can be found in polarizer model NPF SEG1425DU manufactured by Nitto Denko:
T_{Parallel}=88%
T_{Prependicular}<0.04%

The Transmittance (transmission of unpolarized light by a typical single polarizer, T_{Unpolarized}) is given by:

T_{Unpolarized}=(½)T_{Parallel}+(½)T_{Prependicular}

The Contrast Ratio and Transmittance of the typical polarizer cited above, would be ˜2200 and ˜44% respectively.

Thus, since the illumination produced by the backlight is unpolarized light, ˜56% (i.e., 1-T_{Unpolarized}) of the light generated by the backlight is absorbed by polarizer 404 (the rear polarizer); this is a major loss of light generated by the backlight.

To eliminate this major loss of backlight intensity, and thereby improve the brightness efficiency of LCDs, innovators have developed a design known as polarization recycling. With polarization recycling, the unwanted plane of polarization is reflected back towards the backlight rather than lost through absorption in the rear polarizer. Upon reflection towards the backlight, the unwanted plane of polarization undergoes scattering in the backlight unit and ultimately re-emerges in a direction towards the viewer. However, during the scattering process the plane of polarization is rotated and a fraction of the re-emerging light is now in the desired plane of polarization whereupon it is transmitted with relatively high efficiency by the polarizer 404 (e.g., 88% in the example cited above). This process is repetitive and results in additional light of the desired polarization augmenting and adding to that which was originally transmitted by the rear polarizer 404. Thus, through this reflection and scattering process the unwanted plane of polarization is effectively converted into the desired plane of polarization 405 rather than being lost through absorption in the rear polarizer 404.

The initial implementations of polarization recycling were done by adding a separate, specialized reflective film; one that primarily reflects one plane of polarization and transmits the orthogonal plane of polarization (see for example U.S. Pat. Nos. 5,422,756, 5,808,794 and 7,342,619, which are incorporated herein by reference). These specialized reflective films do not have sufficient contrast to be able to eliminate the need for the rear absorptive polarizer; they must be used together with a conventional rear absorptive polarizer. Therefore these initial implementations of polarization recycling add complexity to the construction of a LCD rather than simplify it.

More recent innovators have developed a reflective polarizer technology for LCDs known as wire grid polarizers (see for example U.S. Pat. Nos. 4,049,944 and 6,122,103, which are incorporated herein by reference). Wire grid polarizers, schematically shown in FIG. 2, consist of closely spaced metal lines 412 fabricated on a transparent substrate 414. For unpolarized light 210 illuminating a wire grid polarizer 440, one plane of polarization, s-polarization, 420 is reflected while the orthogonal plane of polarization, p-polarization, 240 is transmitted. To be an efficient polarizer, the periodicity (or pitch) of the metal lines, A, must be at least 2× smaller than the shortest wavelength of light that the wire grid polarizer is intended to polarize.

Wire grid polarizers are fundamentally different than absorptive polarizers; wire grid polarizers reflect the unwanted plane of polarization rather than absorb it. However, unlike the separate films used in the initial implementations of polarization recycling, wire grid polarizers are capable of high contrast which enables them to be capable of replacing the current absorptive rear polarizer and thereby eliminate the need for a separate polarization recycling film (see for example U.S. patent application Ser. Nos. 11/289,660 and 11/566,103). These more recent implementations have the very important advantage of simplifying the construction of LCDs.

As summarized by the cross-sectional views in FIGS. 3A-3D various designs have been developed for wire grid polarizers. The typical basic wire grid polarizer design is illustrated in FIG. 3A; parallel conductive metal lines 412 are fabricated on a transparent substrate 414. FIG. 3B illustrates one innovative way to improve the performance of a basic wire grid polarizer design by fabricating the metal lines on a rib that may be of the same material as the substrate or a different material; if different, preferably of a lower index of refraction than the substrate material (for example see U.S. Pat. No. 6,122,103 and US Patent Application Publication 20070087549, which are incorporated herein by reference). Another innovation, shown in FIG. 3C, is a double sided wire grid polarizer having two sets of conductive lines 412a, 412b on opposite sides of the substrate 414. Examples of such polarizers are described, e.g., in U.S. Pat. Nos. 4,289,381, 4,512,638, and 6,714,350, which are incorporated herein by reference). A further innovation that is particularly important because of its low manufacturing costs and its scalability to be manufactured in large areas is shown in FIG. 3D. In this design the conductive lines 412 are fabricated by an oblique deposition of metal onto spaced-apart protruding surface features 415 created on the substrate 414. The surface features (sometimes referred to herein as “ribs”) may be of the same material as the substrate or another material (see for example US Patent Application Publication 20060159958 and PCT Publication Number WO 2008/042658, which are incorporated herein by reference).

While the reflectivity of wire grid polarizers provides a major improvement for the brightness of LCDs as a rear polarizer for LCDs, the reflectivity of wire grid polarizers makes them unsuitable for use on the front side of the display (the side facing the viewer). The reflectivity of the wire grid polarizer creates a problem when there is ambient light present; the wire grid polarizer reflects ambient light towards the viewer and may seriously diminish the perceived contrast of an LCD.

As indicated in FIG. 4, the total light perceived by the viewer of a LCD 50 is composed of the light produced by the display 130 (I_{LCD}) and any ambient light 120 (I_{Ambient}) that is reflected by the display. Two example pixels are depicted in FIG. 4; an “ON” pixel 102 and an “OFF” pixel 104. For the light produced by the display, the intensity of light from an “ON” pixel (i.e., a bright pixel) 102 is 130a (I_{Max}) and the intensity of an “OFF” pixel (i.e., a dark pixel) 104 is 130b (I_{Min}). The contrast produced by a LCD is the ratio of I_{Max}/I_{Min} . Since in typical LCDs, the contrast values often exceed 1,000, the intensity of the light that is produced by a display for a dark pixel is ˜0.1% or less than that of a bright pixel. However, the contrast perceived by the viewer, is the ratio of the total light perceived to be coming from an “ON” pixel 102 divided by the total light perceived to be coming from an “OFF” pixel 104. Both of these include reflected ambient light.

The intensity of the reflected ambient light 120 from an“ON” pixel 102 and that from an “OFF” pixel 104, is nominally the same. The reflected ambient light is not a problem for an “ON” pixel; the reflected light simply adds to the intensity produced by the display and makes it appear brighter. However, for an “OFF” pixel, since the intensity of the reflected ambient light can be much larger than the light produced by an “OFF” pixel in the display, the perceived contrast is seriously degraded by the reflected ambient light. This is the widely recognized LCD visibility problem in high ambient light situations such as daylight viewing.

To minimize this ambient light visibility problem, LCDs are specifically designed to minimize reflectivity from the front of the display, and often additional coatings or layers are included on the front an LCD to minimize reflectivity. Using a reflective polarizer such as a wire grid polarizer on the front of an LCD would make this visibility problem much worse. Thus, prior art wire grid polarizers are unsuitable for use on the front side of an LCD.

US Patent Application Publication Number 20070242352 (which are incorporated herein by reference) describes a prior attempt to achieve low reflectivity wire grid polarizers. However, this prior art is explicitly for use as a rear polarizer in LCDs and therefore does not address the ambient light visibility problem of wire grid polarizers when used as a front polarizer for LCDs. This prior art strives to solve problems encountered in use as a recycling polarizer on the backlight side of the LCD (i.e., the rear polarizer); it does not address the visibility problems attendant to use of a wire grid polarizer as a front polarizer. In addition, the methods disclosed in US Patent Application Publication Number 20070242352 seek to reduce the reflectivity to ˜40% which will be shown later to be completely inadequate for overcoming the ambient light visibility problem of a wire grid polarizer used on the front side of a LCD. In addition Publication Number 20070242352 teaches reducing the reflectivity of a wire grid polarizer used as the rear polarizer in a LCD. However, reducing the reflectivity of the rear polarizer would reduce or even eliminate the benefit of polarization recycling that could be obtained by using a wire grid polarizer as the rear polarizer.

There is therefore a need for a low reflectivity wire grid polarizer that is suitable for use on the front side of an LCD (the side facing the viewer).

### BRIEF DESCRIPTION OF THE DRAWINGS

Objects and advantages of the invention will become apparent upon reading the following detailed description and upon reference to the accompanying drawings in which:

FIG. 1 is a schematic diagram of a typical LCD of the prior art

FIG. 2 is a schematic diagram of a typical prior art wire grid polarizer

FIGS. 3A-3D are cross-sectional illustrations of several prior art wire grid polarizer designs

FIG. 4 is a description of the ambient light visibility problem of LCDs

FIG. 5 is a cross-sectional view of one embodiment of a low reflectivity wire grid polarizer of the present invention

FIG. 6 is a cross-sectional view of another embodiment of the low reflectivity wire grid polarizer of the present invention

FIG. 7 is a cross-sectional view of a further embodiment of the low reflectivity wire grid polarizer of the present invention.

FIG. 8 is a cross-sectional view of another embodiment of the low reflectivity wire grid polarizer of the present invention

FIG. 9 is a cross-sectional view of another embodiment of the low reflectivity wire grid polarizer of the present invention

FIG. 10 is a cross-sectional view of another embodiment of the low reflectivity wire grid polarizer of the present invention

FIG. 11 is a cross-sectional view of another embodiment of the low reflectivity wire grid polarizer of the present invention

FIG. 12 is a cross-sectional view of another embodiment of the low reflectivity wire grid polarizer of the present invention

FIG. 13 is a schematic diagram of a typical prior art LCD assembly

FIG. 14 is a schematic diagram of an LCD assembly with one embodiment of the low reflectivity wire grid polarizer of the present invention

FIG. 15 is a schematic diagram of an LCD assembly with another embodiment of the low reflectivity wire grid polarizer of the present invention

FIG. 16 is a schematic diagram of an LCD assembly with another embodiment of the low reflectivity wire grid polarizer of the present invention

FIG. 17 is a schematic diagram of an LCD assembly with another embodiment of the low reflectivity wire grid polarizer of the present invention

FIG. 18 is a schematic diagram of an LCD assembly with another embodiment of the low reflectivity wire grid polarizer of the present invention

FIG. 19 is a schematic diagram of an LCD assembly with another embodiment of the low reflectivity wire grid polarizer of the present invention.

FIG. 20 is a schematic diagram of an LCD assembly with another embodiment of the low reflectivity wire grid polarizer of the present invention.

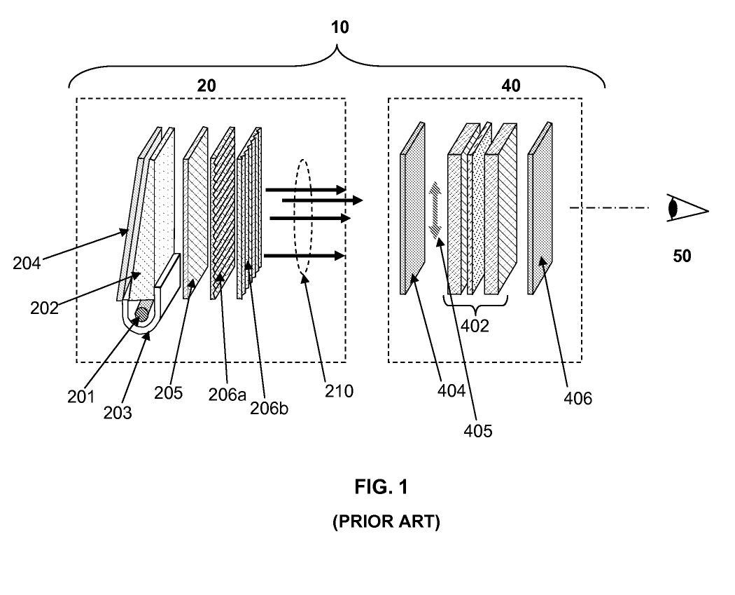

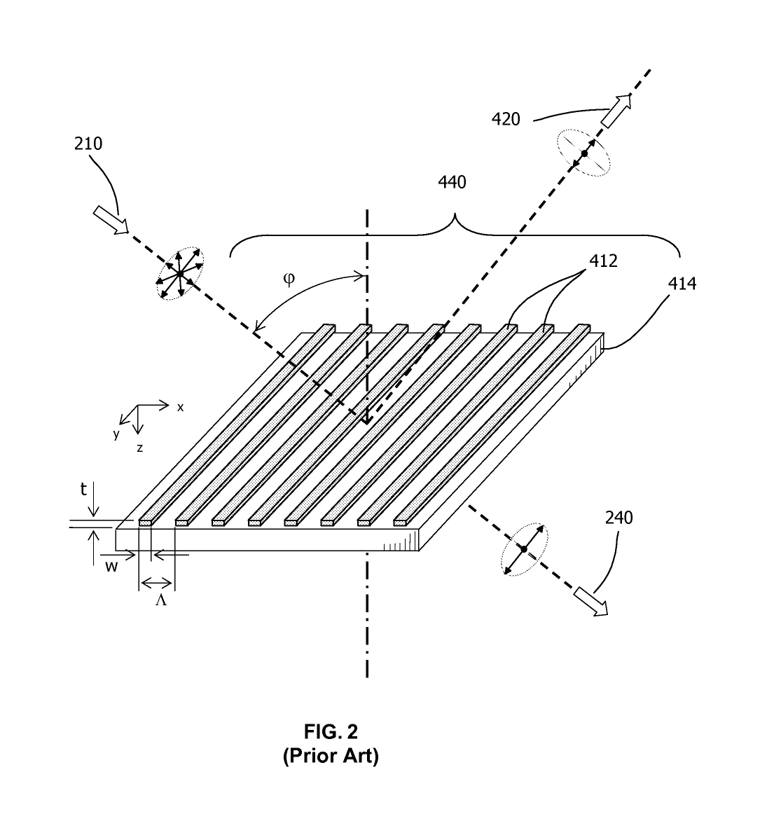

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the embodiments of the invention described below are set forth without any loss of generality to, and without imposing limitations upon, the claimed invention.

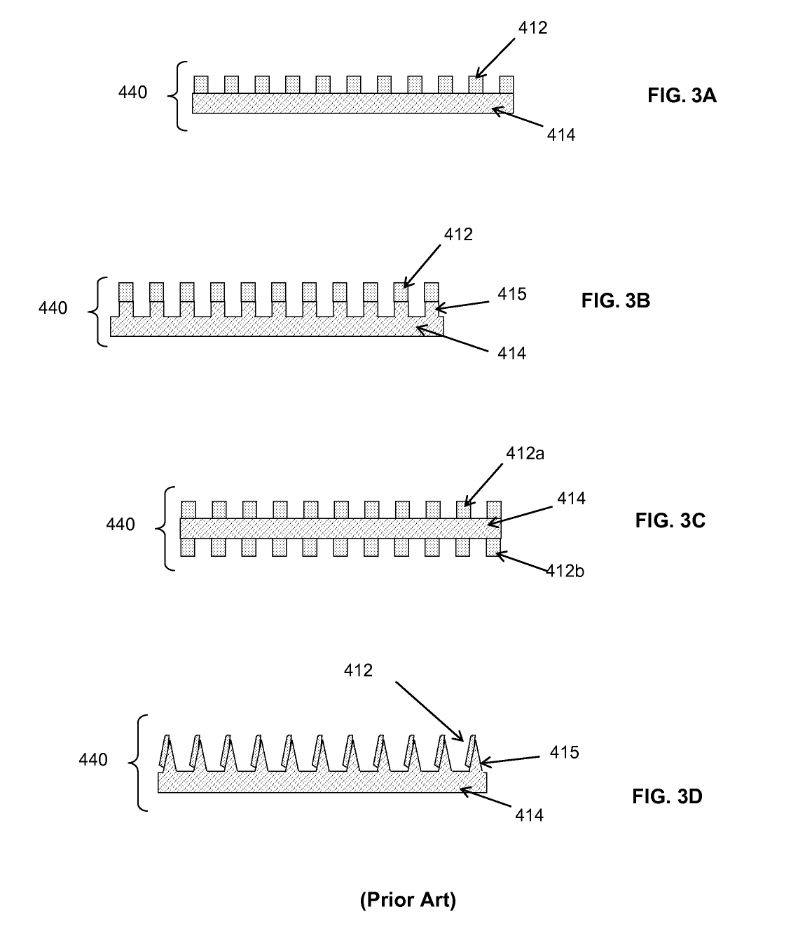

Referring now to the schematic cross-section of the basic wire grid polarizer 440 shown in FIG. 3A, wire grid polarizers consist of an array of very closely spaced parallel conductive lines 412 on a transparent substrate 414. When illuminated with unpolarized light, wire grid polarizers substantially reflect one plane of polarization (s-polarization) and substantially transmit the orthogonal plane of polarization (p-polarization). There are only minor differences in these reflection and transmission properties for light that is incident from the substrate 414 side verses light incident from the side with the conductive metal lines 412. For example, in a typical wire grid polarizer, the s-polarization reflectivity, R_{S}, when illuminated from the side with conductive metal lines is ˜85% while the s-polarization reflectivity, R_{S}, from the substrate side is ˜84%. Thus, prior art wire grid polarizers are essentially equally reflective from either side.

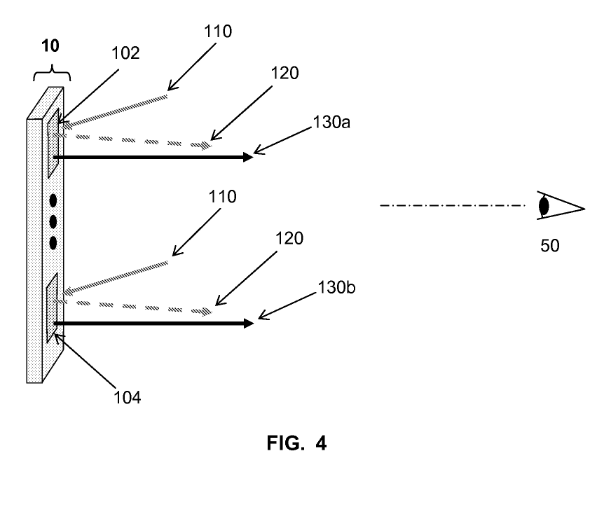

As noted previously, wire grid polarizers reflect the unwanted plane of polarization, rather than absorbing it, as happens with absorptive polarizers. This is a major advantage for wire grid polarizers when they are used on the rear side of a LCD panel (the side facing the backlight assembly). However, the high reflectivity of a wire grid polarizer creates a major visibility problem if used on the front side of a LCD panel (the side facing the viewer 50 in FIG. 4. To prevent severe contrast impairment of a LCD from ambient light, it is desirable to limit the Reflectivity, R, specifically R_{S}, of the wire grid polarizer to to less than 4%, perhaps less than 2%, realistically, between 1% and 2% for at least one direction of illumination.

The present invention describes several embodiments that reduce the reflectivity of a wire grid polarizer from one side while still maintaining the other important advantages of wire grid polarizers; high Transmittance and high Contrast Ratio.

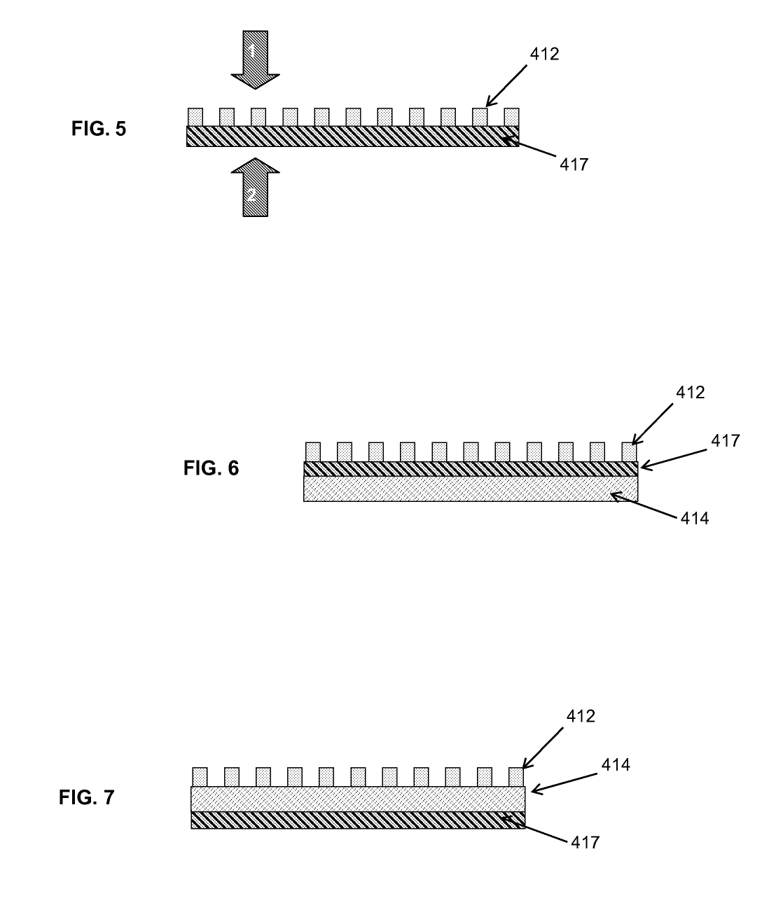

In one embodiment of the present invention, shown schematically in FIG. 5, the array of closely spaced parallel conductive lines constituting the wire grid polarizer is fabricated on a partially absorptive substrate 417 rather than the transparent substrate 414 shown in FIG. 3A. In this embodiment, the absorptive properties of 414 are isotropic; specifically the absorption is the same for both planes of polarization. The absorptive layer 417 attenuates transmitted light by a factor α. In the configuration depicted in FIG. 5, the reflectivity R_{S} for illumination incident from Side 2, will be attenuated by the absorptive layer 417 by a factor of α² (due to the second pass through the absorptive layer after reflection) while the reflectivity for illumination incident from Side 1 will be unchanged. However, due to the isotropic absorption characteristics of 414, the transmission of the desired plane of polarization, T_{Parallel}, of the wire grid polarizer depicted in FIG. 5 will also be attenuated by a factor α relative to the basic wire grid polarizer on a transparent substrate. Since high Transmittance is an important performance attribute of polarizers, reducing the Transmittance by using an isotropic absorption layer is undesirable.

Suitable isotropic absorptive materials that may be used for the absorptive layer 417 are well known and include thin coatings containing black dyes and thin layers of inorganic materials, including but not limited to, CdTe, Ni—P black, and carbon nanotubes.

To avoid attenuating of the light transmitted by the wire grid polarizer of FIG. 5, a preferred embodiment uses an absorptive polarizer as the substrate 417 rather than an isotropic absorptive layer. Using an absorbing polarizer material as the absorption layer with its axis of strong absorption aligned parallel to the length of the conductive wires as the substrate 417 will attenuate the reflection R_{S}, by a factor of α² as before, while minimally impacting the transmission of the desired plane of polarization T_{Perpendicular}. This accomplishes the desired goal of attenuating the reflectivity R_{S} for illumination incident from Side 2 while not significantly impairing the transmission of light from Side 2 (or from Side 1).

Suitable anisotropic absorption materials for this preferred embodiment can be found in the materials commonly used for absorptive polarizers; iodine complexes and anisotropic dyes. It should be noted that typical polarizer films strive for large attenuation factors (e.g., <0.04% for the unwanted plane of polarization) while attenuation factors of just 20% are adequate for reducing the reflectivity of the wire grid polarizer to less than 4%. Therefore the concentration of the anisotropic absorptive material and or its thickness can be much less that that typically used in absorptive polarizers.

Two other embodiments of the principle employed in the embodiment depicted in FIG. 5, are shown in FIG. 6 and FIG. 7. In these embodiments, the absorptive polarizer 417 may be just a layer on a transparent substrate 414 rather than constitute the entire substrate as indicated in FIG. 5. In the embodiment illustrated in FIG. 6, the absorptive layer 417 is disposed between the conductive metal lines 412 and the transparent substrate 414 while in the embodiment illustrated in FIG. 7 the transparent substrate 414 is disposed between the conductive metal lines 412 and the absorptive layer 417. In each of these two embodiments, the axis of strong absorption of the absorptive polarizer material is oriented parallel to the length of the conductive lines constituting the wire grid polarizer. In this way, as before, the reflection R_{S} of the wire grid polarizer is strongly attenuated while the transmission T_{Perpendicular} of the wire grid polarizer is substantially unaffected.

In the further embodiment illustrated in FIG. 8, the absorptive material 417 is restricted to just the area substantially underneath the conductive metal lines 412. In this embodiment the absorptive material may be either an isotropic absorption material or an oriented absorptive material like an absorptive polarizer. This embodiment achieves the desired goal of low reflectivity R_{S} for light incident from Side 2 while having high Transmittance for light incident from either direction.

Several methods can be used to fabricate the structure indicated in FIG. 8; a preferred approach is to coat the absorptive material 417 on the substrate 414 before fabricating the parallel conductive metal lines 412 that constitute the wire grid polarizer then use the parallel conductive lines as a (self-aligned) etch mask to remove the exposed areas of the absorptive material. There are several suitable etching techniques for removing the unwanted absorptive material but the preferred technique is a reactive ion etch.

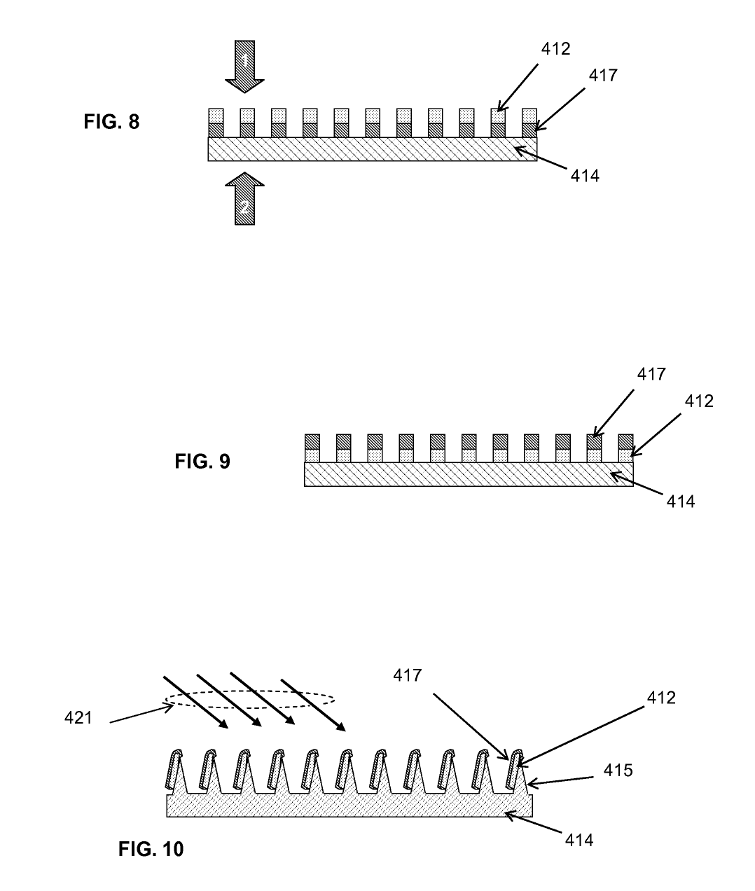

In an alternative embodiment, shown in FIG. 9, the absorptive material 417 is substantially disposed on top of the conductive metal lines 412. In this embodiment the absorptive material may be either an isotropic absorption material or an oriented absorptive material like an absorptive polarizer. Light incident from the side with the conductive metal lines and the absorptive layer (Side 1 using the same nomenclature that was used before) has low reflectivity R_{S} while maintaining high Transmittance for light incident from either direction.

Several methods can be used to fabricate the structure depicted in FIG. 9; the preferred approach is to fabricate the parallel conductive metal lines that constitute the wire grid polarizer and then use an oblique vacuum deposition of an absorptive material to coat substantially just the upper surface of the conductive metal lines. Suitable materials for the absorptive material include but not limited to, CdTe, Ni—P black, and carbon nanotubes.

In yet another embodiment, shown in FIG. 10, the absorptive material 417 is a coating on the outer surface of conductive metal lines. In this configuration, light incident from the side with the conductive metal lines and the absorptive coating (Side 1, using the same nomenclature that was used before) has low reflectivity R_{S} while the reflectivity for light incident from the substrate side (Side 2) has the normally high reflectivity of a conventional wire grid polarizer. The Transmittance of this embodiment remains high for light incident from either direction.

In the embodiment depicted in FIG. 10, the absorptive material 417 could be deposited by an oblique evaporation 421 subsequent to the oblique evaporation 421 used to fabricate the conductive metal lines 412.

A preferred alternative method to fabricate the structure depicted in FIG. 10, is to form the absorptive coating 41. Alternatively, the absorptive material 417 by a chemical reaction that tarnishes or makes less reflective the surface of the conductive metal lines 412 that were produced by the oblique evaporation 421. Suitable materials for this preferred method include but are not limited to silver metal treated with sulfides to convert the surface to a black Ag₂S coating or aluminum metal treated with commonly available blackening agents such as the product Aluma Black A15 sold by the Birchwood-Casey Corp. of Eden Prairie, Minn. In the example depicted in FIG. 10, the conductive metal lines 412 and absorptive material 417 are formed on one side of ribs 415 having substantially triangular cross-sections. As used herein, the term “substantially triangular” means that the surface features are characterized by two sides that meet at a vertex. The sides need not be straight in cross-section, i.e., they may be curved. In addition, the vertex need not be perfectly sharp, e.g., it may be rounded as a result of limitations of manufacturing processes used to form the ribs 415.

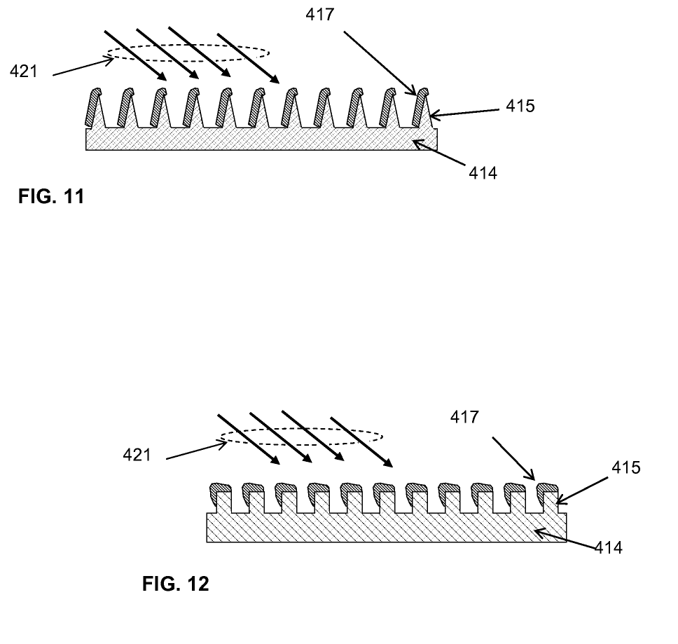

In yet a further embodiment, illustrated in FIG. 11, the entire metal coating 412 is absent, having been replaced by an absorptive material 417. The absorptive material 417 can be the result of the complete chemical conversion of an obliquely deposited metal to an absorptive material or it can be a material that is absorptive as deposited obliquely. It is anticipated that shapes of the ribs 415 upon which the material is obliquely deposited may be other than substantially triangular in cross-section, as indicated in FIG. 11. One example, among others, is a rectangular shaped cross-section for the ribs 415, as depicted in FIG. 12.

Suitable materials for the conversion of a metal 412 to an absorptive material 417 include but are not limited to silver metal treated with sulfides to convert the surface to a black Ag₂S coating or aluminum metal treated with commonly available blackening agents such as the product Aluma Black A15 sold by the Birchwood-Casey Corp. of Eden Prairie, Minn. Suitable materials for directly depositing an absorptive material include but not limited to, CdTe, Ni—P black, and carbon nanotubes.

The wire grid polarizer designs disclosed above have the characteristic of low reflectivity, from at least one side, while retaining the high transmission of conventional wire grid polarizer designs. It is herein a further invention to use these designs disclosed above as a front polarizer in LCDs.

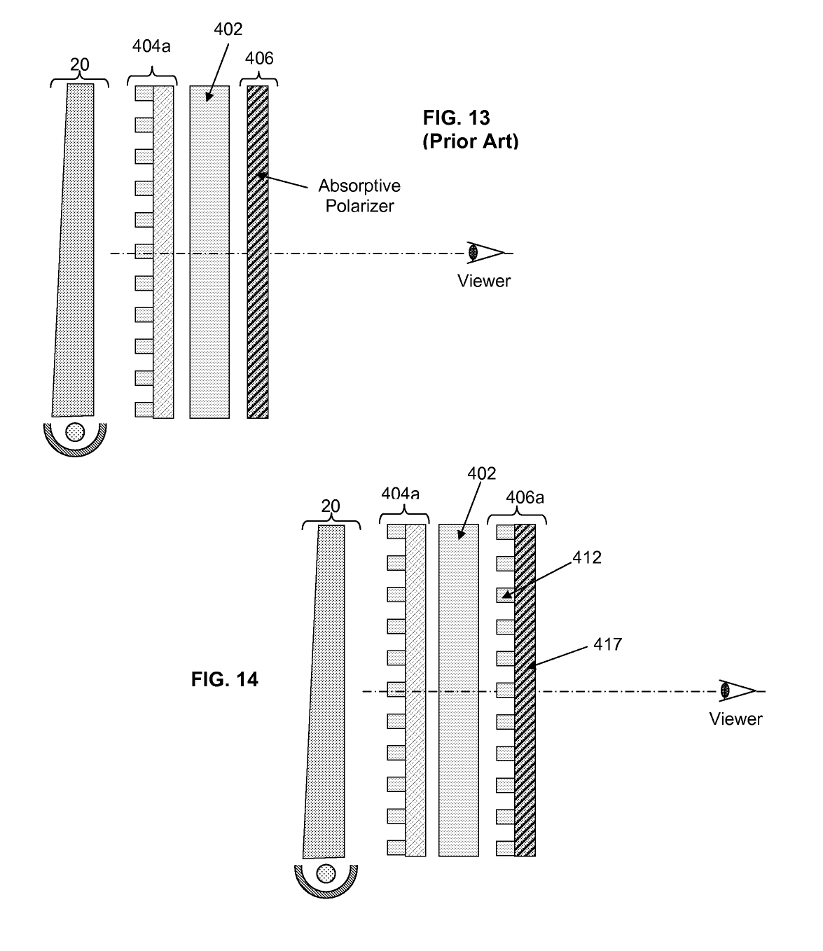

The geometry of a typical LCD is shown in FIG. 13. In all prior art direct view LCDs, the front polarizer 406 is an absorptive polarizer while the rear polarizer 404 can be either an absorptive polarizer or, as shown in the figure, a wire grid polarizer 404a. It is understood that there may be additional films or layers on the front polarizer or associated with it which are not shown in FIG. 13 or subsequent drawings. These additional films or layers include, but are not limited to, adhesive layers, protective films anti-scratch, anti-reflective, and anti-static layers or films.

For the reasons discussed above, it is desirable to limit the Reflectivity, R, specifically R_{S}, of the front wire grid polarizer 406 to less than 4%, perhaps less than 2%, realistically, between 1% and 2% from the viewing side in order to prevent severe contrast impairment of a LCD from ambient light. Reflectivity greater than about 4% is not sufficient to prevent contrast impairment of a LCD for most conditions of ambient light. The back side (that is the side opposite the viewing or front side) of the front wire grid polarizer 406 is preferably highly reflecting (e.g., greater than about 75% reflectivity for the metallic lines, more preferably, greater than about 80%). This allows the back side of the front wire grid polarizer to be used for polarization recycling.

In a preferred embodiment, the rear wire grid polarizer 404a is characterized by a wire grid having relatively high reflectivity (e.g., a reflection coefficient Rₛ greater than about 75%, more preferably greater than about 80%, for the metallic lines on both sides (i.e., the front or viewing side and the back side opposite the viewing side) for the S plane of polarization. Relatively high reflectivity is particularly desirable so that the rear wire grid polarizer can be used for polarization recycling.

An improvement over the prior art designs is shown in FIG. 14. In the embodiment depicted in FIG. 14 a low reflectivity wire grid polarizer 406a, of the type illustrated in FIG. 5, with the low reflectivity side facing the viewer 50 replaces the conventional absorptive type front polarizer. Note that in this embodiment, the absorptive material 417 is placed on a viewing side of the display, between the plurality of metal lines 412 of the front polarizer 406a and the viewer 50. In this configuration, the low reflectivity front wire grid polarizer 406a does not degrade the perceived contrast beyond that of a typical prior art absorptive polarizer. However, the lower cost and higher contrast available with wire grid polarizers relative to absorptive polarizers, enables LCDs to be manufactured at lower cost and with higher performance.

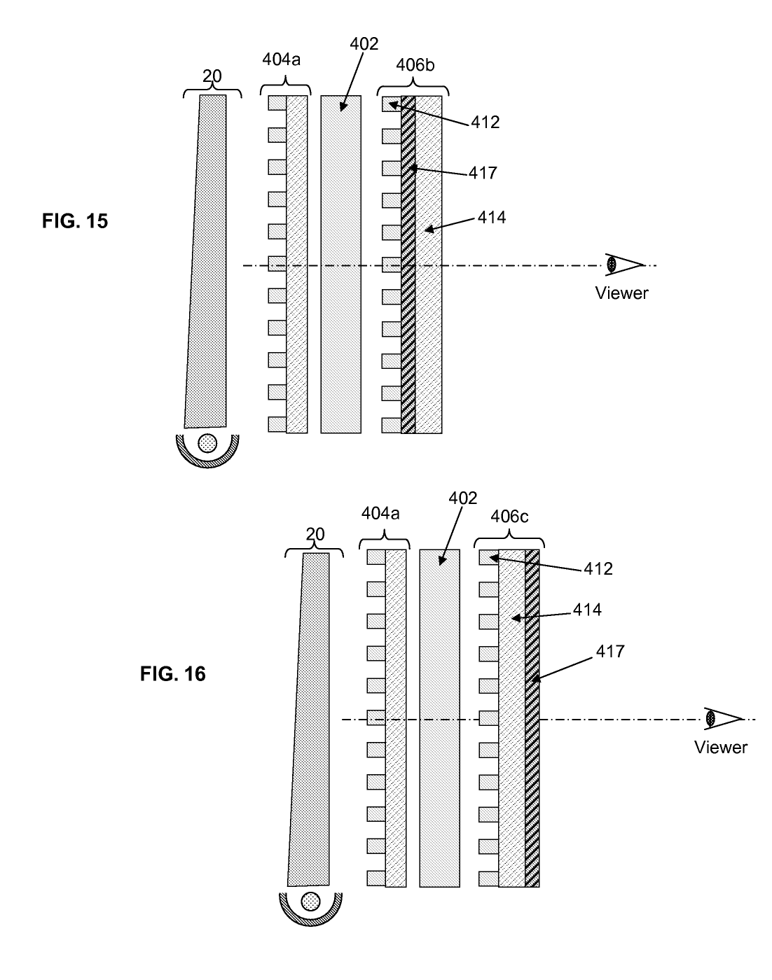

An alternative embodiment of a low reflectivity wire grid polarizer used as a front polarizer in a direct view LCD is shown in FIG. 15. In this embodiment the low reflectivity wire grid polarizer is of the type depicted in FIG. 6.

Another embodiment of a low reflectivity wire grid polarizer used as a front polarizer in a direct view LCD is shown in FIG. 16. In this embodiment the low reflectivity wire grid polarizer is of the type depicted in FIG. 7.

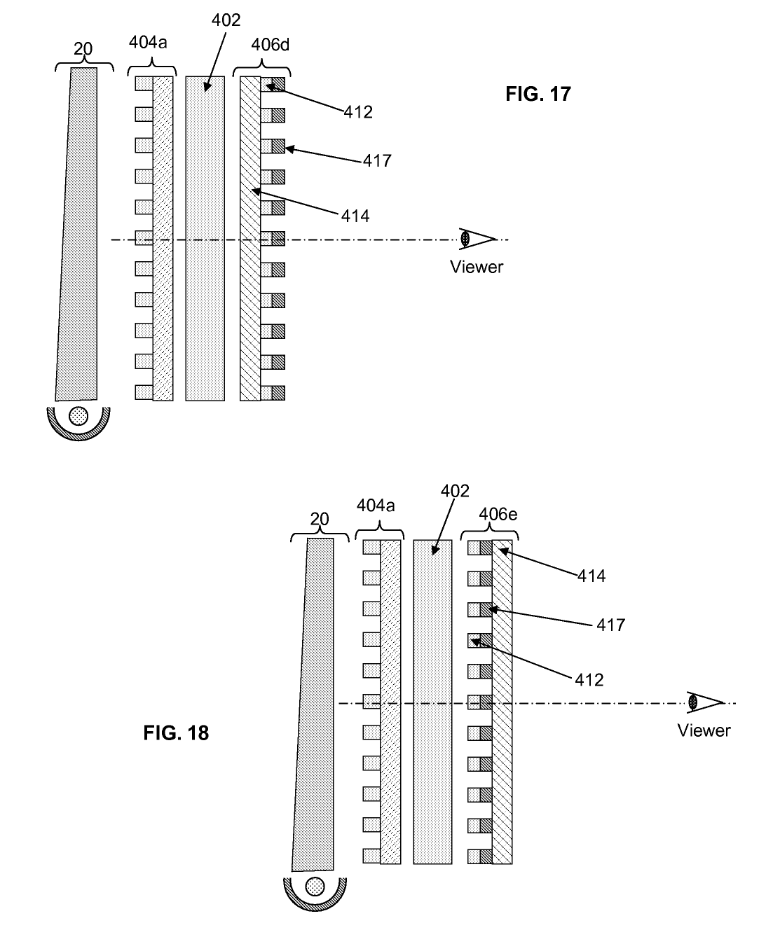

A further embodiment of a low reflectivity wire grid polarizer used as a front polarizer in a direct view LCD is shown in FIG. 17. In this embodiment the low reflectivity wire grid polarizer is of the type depicted in FIG. 8.

A further embodiment of a low reflectivity wire grid polarizer used as a front polarizer in a direct view LCD is shown in FIG. 18. In this embodiment the low reflectivity wire grid polarizer is of the type depicted in FIG. 9.

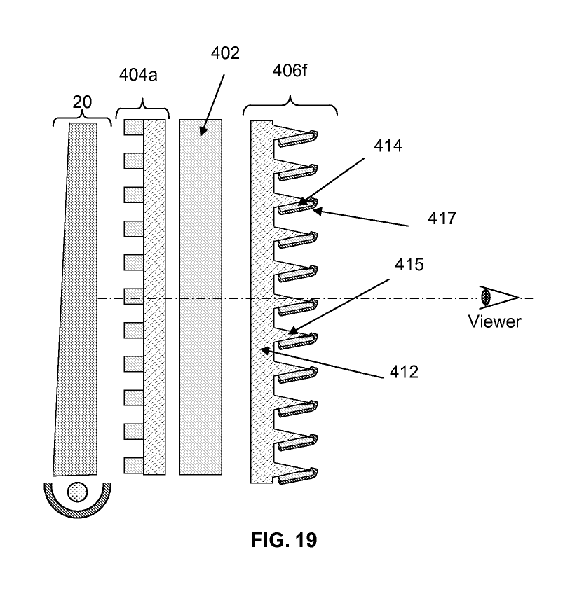

A further embodiment of a low reflectivity wire grid polarizer used as a front polarizer in a direct view LCD is shown in FIG. 19. In this embodiment the low reflectivity wire grid polarizer is of the type depicted in FIG. 10.

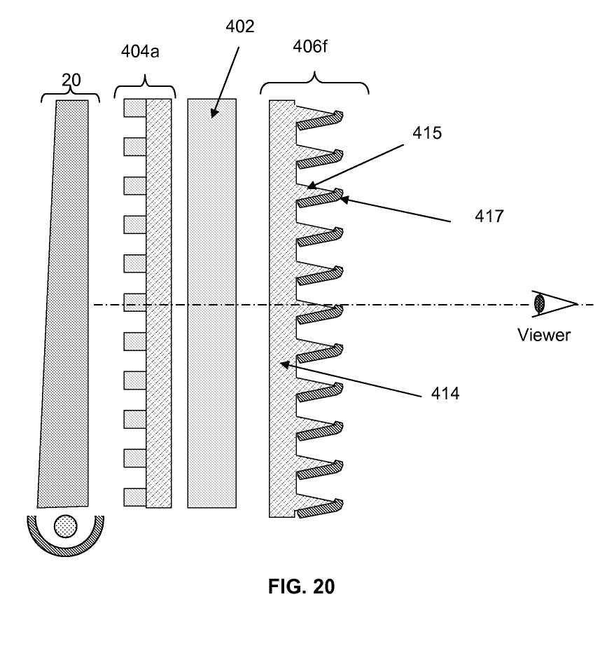

A further embodiment of a low reflectivity wire grid polarizer used as a front polarizer in a direct view LCD is shown in FIG. 20. In this embodiment the low reflectivity wire grid polarizer is of the type depicted in FIG. 11.

What is claimed

1. A wire grid polarizer, comprising:
a plurality of closely spaced parallel metallic lines; and
an optically absorptive material disposed proximate one side of said plurality of closely spaced parallel metallic lines wherein the optically absorptive material is configured such that said wire grid polarizer is characterized by reflectivity of less than 4%.

2. The wire grid polarizer of claim 1 wherein the optically absorptive material is configured such that said wire grid polarizer is characterized by reflectivity from said one side that is suitable for use on a front (viewer) side of a liquid crystal display (LCD).

3. The wire grid polarizer of claim 1 wherein the optically absorptive material is configured such that said wire grid polarizer is characterized by reflectivity of less than 2%.

4. The wire grid polarizer of claim 1 wherein the optically absorptive material is configured such that said wire grid polarizer is characterized by reflectivity of between 1% and 2%.

5. The wire grid polarizer of claim 1 wherein the optically absorptive material comprises a layer of optically absorptive material and wherein the plurality of closely spaced parallel metallic lines is disposed on a surface of the layer.

6. The wire grid polarizer of claim 3, further comprising a layer of transparent material, wherein the layer of optically absorptive material is disposed between the plurality of closely spaced parallel metallic lines and the layer of transparent material.

7. The wire grid polarizer of claim 5, further comprising a layer of transparent material disposed between the plurality of closely spaced parallel metallic lines and the layer of optically absorptive material.

8. The wire grid polarizer of claim 1, wherein the optically absorptive material is in the form of an optically absorptive coating on surfaces on said closely spaced parallel metallic lines on said one side, but not on a second side opposite said one side.

9. The wire grid polarizer of claim 8, further comprising a layer of transparent material, wherein the optically absorptive coating is disposed between the plurality of metal lines and the layer of transparent material.

10. The wire grid polarizer of claim 8, further comprising a layer of transparent material, wherein the plurality of metal lines is disposed between the optically absorptive coating and the layer of transparent material.

11. The wire grid polarizer of claim 8, further comprising a substrate having a plurality of ribs, wherein the plurality of metal lines is formed on the plurality of protruding surface features.

12. The wire grid polarizer of claim 11 wherein the ribs are substantially triangular in cross-section and each metal line in the plurality is formed on one side of a vertex of a corresponding protruding surface feature.

13. A liquid crystal display comprising:
a rear polarizer comprising a wire grid polarizer having a first plurality of closely spaced parallel metallic lines;
a front polarizer comprising a second plurality of closely spaced parallel metallic lines; and an optically absorptive material disposed proximate a viewing side of said second plurality of closely spaced parallel metallic lines; and
a liquid crystal array disposed between the front polarizer and the rear polarizers.

14. The liquid crystal display of claim 13 wherein the optically absorptive material is configured such that said wire grid polarizer is characterized by reflectivity from said viewing side that is suitable for use on a front (viewer) side of the liquid crystal display (LCD).

15. The liquid crystal display of claim 13 wherein the optically absorptive material is configured such that said wire grid polarizer is characterized by reflectivity of less than 4%.

16. The liquid crystal display of claim 13 wherein the optically absorptive material is configured such that said wire grid polarizer is characterized by reflectivity of between 1% and 2%

17. The liquid crystal display of claim 13 wherein front and back sides of said rear polarizer is characterized by a reflectivity of greater than about 75%.

18. The liquid crystal display of claim 13 wherein the front and back sides of said rear polarizer is characterized by a reflectivity of greater than about 80%.

19. The liquid crystal display of claim 13 wherein the optically absorptive material comprises a layer of optically absorptive material and wherein the second plurality of closely spaced parallel metallic lines is disposed on a surface of the layer.

20. The liquid crystal display of claim 19, further comprising a layer of transparent material, wherein the layer of optically absorptive material is disposed between the second plurality of closely spaced parallel metallic lines and the layer of transparent material.

21. The liquid crystal display of claim 19, further comprising a layer of transparent material disposed between the second plurality of closely spaced parallel metallic lines and the layer of optically absorptive material.

22. The liquid crystal display of claim 13, wherein the optically absorptive material is in the form of an optically absorptive coating on surfaces on said second plurality of closely spaced parallel metallic lines on said viewing side, but not on a second side opposite said viewing side.

23. The liquid crystal display of claim 22, further comprising a layer of transparent material, wherein the optically absorptive coating is disposed between the second plurality of metal lines and the layer of transparent material.

24. The liquid crystal display of claim 22, further comprising a layer of transparent material, wherein the second plurality of metal lines is disposed between the optically absorptive coating and the layer of transparent material.

25. The liquid crystal display of claim 22, wherein front polarizer further comprises a substrate having a plurality of ribs, wherein the second plurality of metal lines is formed on the plurality of protruding surface features.

26. The liquid crystal display of claim 22 wherein the ribs are substantially triangular in cross-section and each metal line in the plurality is formed on one side of a vertex of a corresponding protruding surface feature.

27. A polarizer, comprising:
a substrate having a plurality of ribs; and
an optically absorptive material disposed on said ribs proximate one side of said ribs.

28. The polarizer of claim 27 wherein the absorptive material is an isotropic absorptive material.

29. The polarizer of claim 27 wherein the absorptive material is an oriented absorptive material that preferably absorbs light polarized in a particular direction with respect to the ribs.

30. The polarizer of claim 27 wherein the optically absorptive material is configured such that said polarizer is characterized by reflectivity of less than 4%.

31. The wire grid polarizer of claim 27 wherein the optically absorptive material is configured such that said polarizer is characterized by reflectivity of less than 2%.

32. The wire grid polarizer of claim 27 wherein the optically absorptive material is configured such that said polarizer is characterized by reflectivity of between 1% and 2%.

33. A liquid crystal display comprising:
a rear polarizer comprising a wire grid polarizer having a first plurality of closely spaced parallel metallic lines;
a front polarizer comprising a substrate having a plurality of ribs and an optically absorptive material disposed on said ribs proximate one side of said ribs.; and
a liquid crystal array disposed between the front polarizer and the rear polarizers.
